(19) United States
(12) Patent Application Publication
(10) Pub. No.: US 2013/0344364 A1
(43) Pub. Date: Dec. 26, 2013

(54) LITHIUM ION SECONDARY BATTERY

(71) Applicants: Takeshi Nanaumi, Hitachinaka (JP); Takayuki Mitani, Hitachinaka (JP); Katsunori Suzuki, Nabari (JP); Hideki Shinohara, Hitachiota (JP)

(72) Inventors: Takeshi Nanaumi, Hitachinaka (JP); Takayuki Mitani, Hitachinaka (JP); Katsunori Suzuki, Nabari (JP); Hideki Shinohara, Hitachiota (JP)

(73) Assignee: Hitachi Vehicle Energy, Ltd., Hitachinaka-shi, Ibaraki (JP)

(21) Appl. No.: 13/996,342

(22) PCT Filed: Dec. 21, 2011
(86) PCT No.: PCT/JP2011/079647

§ 371 Date: Sep. 12, 2013

(30) Foreign Application Priority Data
Dec. 24, 2010 (JP) 2010-288258

(51) Int. Cl. H01M 10/04; H01M 4/13

(52) U.S. Cl. CPC H01M 10/0431; H01M 4/13
USPC 429/94

(57) ABSTRACT

A lithium ion secondary battery in which a winding type electrode group including a positive electrode having a positive electrode mix layer containing a lithium metal oxide, a negative electrode having a negative mix layer that stores and discharges lithium ions, and separators arranged on inner and outer peripheries of the positive electrode and the negative electrode is housed, and a nonaqueous electrolyte is poured, within a battery container, the positive electrode has one side edge along a longitudinal direction thereof exposed as a positive electrode mix unprocessed portion, and a positive electrode mix layer coated in the other area on both surfaces of a metal foil made of an aluminum alloy.

### TECHNICAL FIELD

The present invention relates to a lithium ion secondary battery, and more particularly to a lithium ion secondary battery which is capable of improving a performance of a positive electrode on which a positive electrode mix containing a positive electrode active material is formed.

### BACKGROUND ART

One type of the lithium ion secondary batteries includes a winding type electrode group that winds a positive electrode having a positive electrode mix layer, a negative electrode having a negative electrode mix layer, and a separator that interposed between those electrodes.

The positive electrode mix layer contains a positive electrode active material made of lithium metal oxide, and the negative electrode mix layer contains a negative electrode active material that can store and discharge lithium ions such as graphite. The separator has holes through which the lithium ions penetrate. Lithium is stored in a state of ions between the positive electrode mix layer and the negative electrode mix layer during charging.

The mix layers of the positive and negative electrodes are coated on both surfaces of a sheet-like metal foil, and dried. The mix layers are coated so that one side edge along a longitudinal direction thereof is exposed as a mix unprocessed portion. In a rectangular lithium ion secondary battery, an electrode current collector is welded to the mix unprocessed portion. Also, in a cylindrical lithium ion secondary battery, a large number of electrode leads extending in an axial direction are formed on the mix unprocessed portion, and the electrode leads are welded to the electrode current collector.

In the positive and negative electrodes, after the mix layer has been thermally pressed, and dried, the metal foil is cut up so that the mix unprocessed portion having a given width is formed.

After the metal foils of the positive and negative electrodes have been cut up, if surfaces of the respective electrodes have deformation such as rucks or corrugation, positions of end potions of the positive and negative electrodes are misaligned during a winding process, and a current is concentrated on the misaligned end portions during charging and discharging. For that reason, internal short-circuiting is generated due to dendrite deposition, or a battery performance is degraded.

However, in a process of thermally pressing the mix layers of the positive and negative electrodes, the metal foil strains, and the end portions of the positive and negative electrodes are not prevented from being misaligned due to this stain.

As a countermeasure thereagainst, there has been known a method in which after the mix layer is coated on one surface of each metal foil of the positive and negative electrodes, and dried, the metal foil is discontinuously notched. Thereafter, the mix layer is formed on the other surface of the metal foil, and pressure-molded by a roller press machine to form the positive and negative electrodes (for example, refer to Patent Literature 1).

### CITATION LIST

### Patent Literature

Patent Literature 1: JP-A-Hei-7 (1995)-192726

### SUMMARY OF INVENTION

### Technical Problem

In the above prior literature 1, after the mix layer is formed on one surface of each metal foil of the positive and negative electrodes, the metal foil is discontinuously notched, the number of processes is increased. This causes an increase in the costs.

### Solution to Problem

According to a first aspect of the present invention, there is provided a lithium ion secondary battery in which a winding type electrode group including a positive electrode having a positive electrode mix layer containing a lithium metal oxide, a negative electrode having a negative electrode mix layer that stores and discharges lithium ions, and separators arranged on inner and outer peripheries of the positive electrode and the negative electrode is housed, and a nonaqueous electrolyte is poured, within a battery container, in which the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Expression (1) when it is assumed that a width of a continuous area portion of the positive electrode mix unprocessed portion is a, and a width of the positive electrode mix layer is b.

Y≧19.6×(a/b)+35.0 (1)

where Y is an inclination of a line connecting a cross point between a 0.2% bearing force and a strain at that time, and a point of strain=0 and stress=0 in a stress-strain characteristic curve.

According to a second aspect of the present invention, there is provided a lithium ion secondary battery in which a winding type electrode group including a positive electrode having a positive electrode mix layer containing a lithium metal oxide, a negative electrode having a negative electrode mix layer that stores and discharges lithium ions, and separators arranged on inner and outer peripheries of the positive electrode and the negative electrode is housed, and a nonaqueous electrolyte is poured, within a battery container, in which the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Condition (I) or Condition (II) when it is assumed that a width of a continuous area portion of the positive electrode mix unprocessed portion is a, and a width of the positive electrode mix layer is b.

Y is equal or larger than 36.7 GPa, and (a/b) is equal to or lower than 0.09 Condition (I), and

Y is equal or larger than 35.7 GPa, and (a/b) is equal to or lower than 0.04 Condition (II)

where Y is an inclination of a line connecting a cross point between a 0.2%; bearing force and a strain at that time, and a point of strain ˜0 and stress=0 in a stress-strain characteristic curve.

According to a third aspect of the present invention, in the lithium ion secondary battery according to the first or second aspect, it is preferable that a ratio of the width a of the continuous area portion of the positive electrode mix unprocessed portion and the width b of the positive electrode mix layer satisfies 0.01≦(a/b)≦0.09.

According to a fourth aspect of the present invention, in the lithium ion secondary battery according to the first or second aspect, it is preferable that a ratio of the width a of the continuous area portion of the positive electrode mix unprocessed portion and the width b of the positive electrode mix layer satisfies 0.03≦(a/b)≦0.09.

According to a fifth aspect of the present invention, in the lithium ion secondary battery according to the first to fourth aspects, it is preferable that a thickness of the metal foil is 10 to 20 μm.

According to a sixth aspect of the present invention, in the lithium ion secondary battery according to the first to fifth aspects, it is preferable that the winding type electrode group is a cylindrical, and the positive electrode mix unprocessed portion has a positive electrode lead extended from the continuous area portion to an external.

### Advantageous Effects of Invention

According to the lithium ion secondary battery of the present invention, the degree of curvature of the positive electrode can be reduced without increasing the number of processes.

In this case, the curvature means that the positive electrode is deformed into a fan shape with the positive electrode mix unprocessed portion side as an inner peripheral side, and the positive electrode mix layer as an outer peripheral side in a state where the positive electrode is viewed in a plan view.

### BRIEF DESCRIPTION OF DRAWINGS

FIG. 1 is a cross-sectional view of a lithium ion secondary battery according to an embodiment of the present invention.

FIG. 2 is an exploded perspective view of the lithium ion secondary battery illustrated in FIG. 1.

FIG. 3 is a perspective view illustrating an electrode group illustrated in FIG. 1 in detail which is partially cut.

FIG. 4 is a plan view of positive and negative electrodes and separators of the electrode group illustrated in FIG. 3 which are partially developed.

FIG. 5 is a perspective view illustrating a first process illustrating a method of forming the positive electrode.

FIG. 6 is a plan view illustrating a process subsequent to FIG.

FIG. 7 is a plan view illustrating a process subsequent to FIG. 6.

FIG. 8 is a perspective view illustrating a process subsequent to FIG. 7.

FIG. 9 is a diagram illustrating a process subsequent to FIG. 8, in which (A) is a plan view of the positive electrode before the positive electrode is cut along a longitudinal direction thereof, and (B) is a plan view of the positive electrode which is cut along the longitudinal direction.

FIG. 10 is a diagram illustrating a reason why the positive electrode is curved into a fan shape, in which (A) illustrates a residual stress or a strain in a state of a coating process of a positive electrode mix, (B) illustrates the residual stress or the strain in a state of the positive electrode before the positive electrode is cut along the longitudinal direction, and (C) illustrates the residual stress or the strain in a state in which the positive electrode is cut along the longitudinal direction.

FIG. 11 is a partially cross-sectional view of FIG. 8.

FIG. 12 is a plan view illustrating the residual stress or the strain when a single positive electrode is taken.

FIG. 13 is a diagram illustrating a method of obtaining an inclination Y from a stress-strain characteristic curve.

FIG. 14 is a diagram illustrating measurement results between respective examples and a comparative example.

FIG. 15 is a diagram of an inclination Y-a/b characteristic.

FIG. 16 is a diagram illustrating an upper limit of an inclination Y in the stress-strain characteristic curve.

### DESCRIPTION OF EMBODIMENT

### (Overall Configuration of Secondary Battery)

Hereinafter, a lithium ion secondary battery according to the present invention will be described with a cylindrical battery as an embodiment with reference to the drawings.

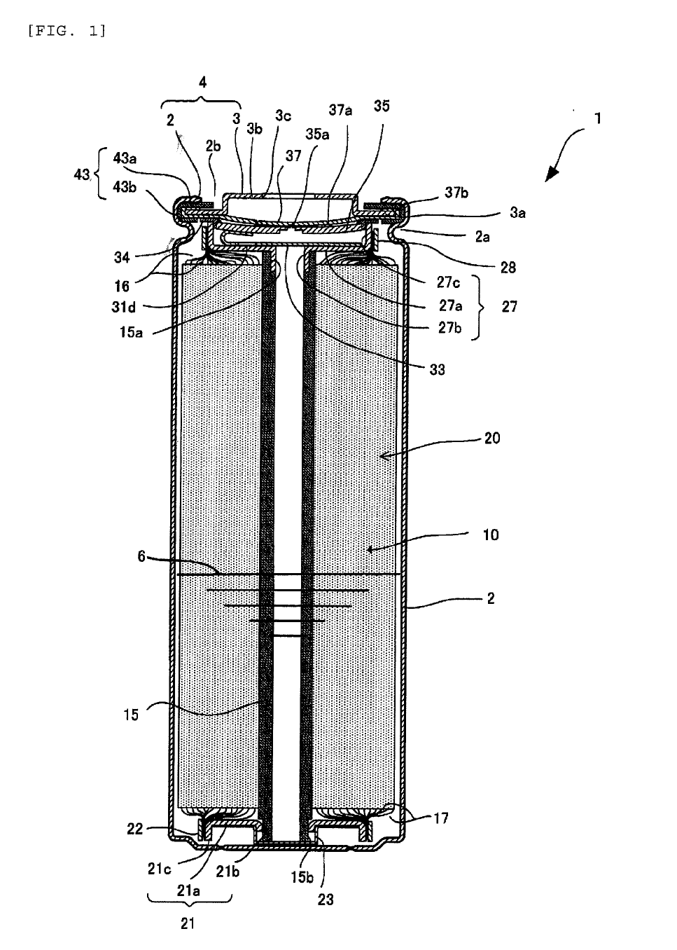

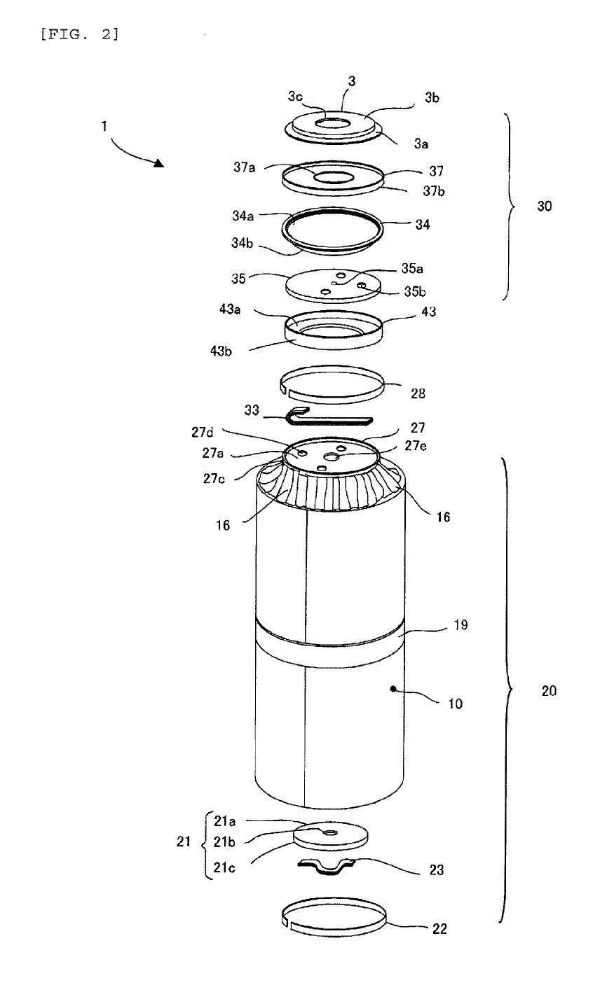

FIG. 1 is a cross-sectional view of a lithium ion secondary battery according to an embodiment of the present invention, and FIG. 2 is an exploded perspective view of the lithium ion secondary battery illustrated in FIG. 1.

A cylindrical lithium ion secondary battery 1 has dimensions of, for example, 40 mmφ in outer shape and 100 mm in height.

The lithium ion secondary battery 1 has a battery container 4 to be structured to be closely sealed from the external in which a battery can 2 having a bottomed cylindrical shape, and a hat-type battery cap 3 are caulked through a seal member 43 which is normally called “gasket”. The bottomed cylindrical battery can 2 is formed by pressing a metal plate made of iron or the like, and a plating layer made of nickel or the like is formed on an overall surface of an inner surface and an outer surface. The battery can 2 has an opening portion 2b in an upper end side which is an open side. A groove 2a protruded toward an inside of the battery can 2 is formed on the opening portion 2b side of the battery can 2. The respective constituent members for power generation which will be described below are housed within the battery can 2.

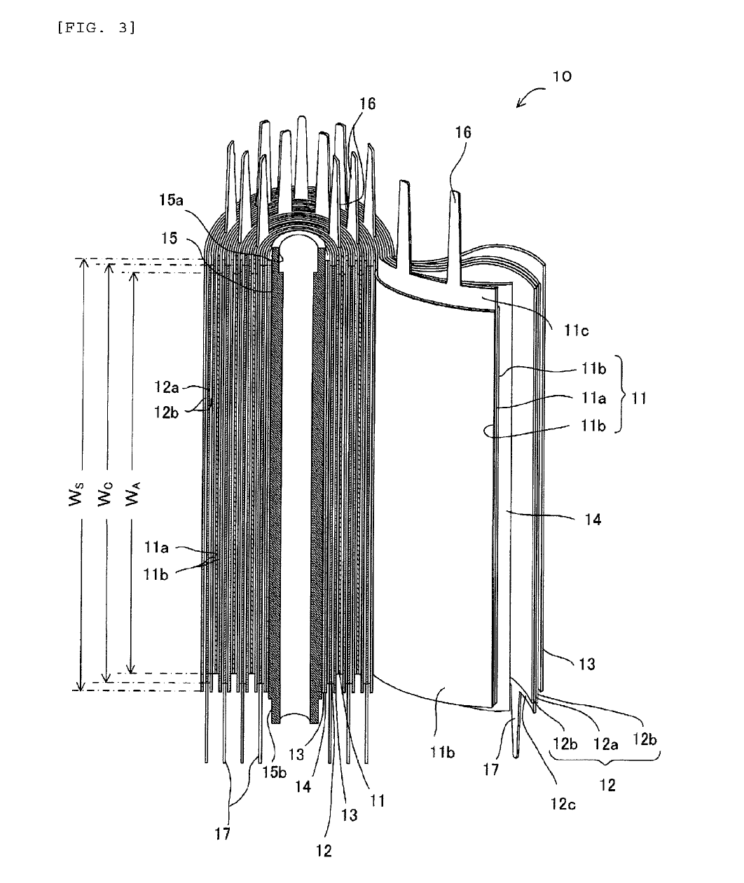

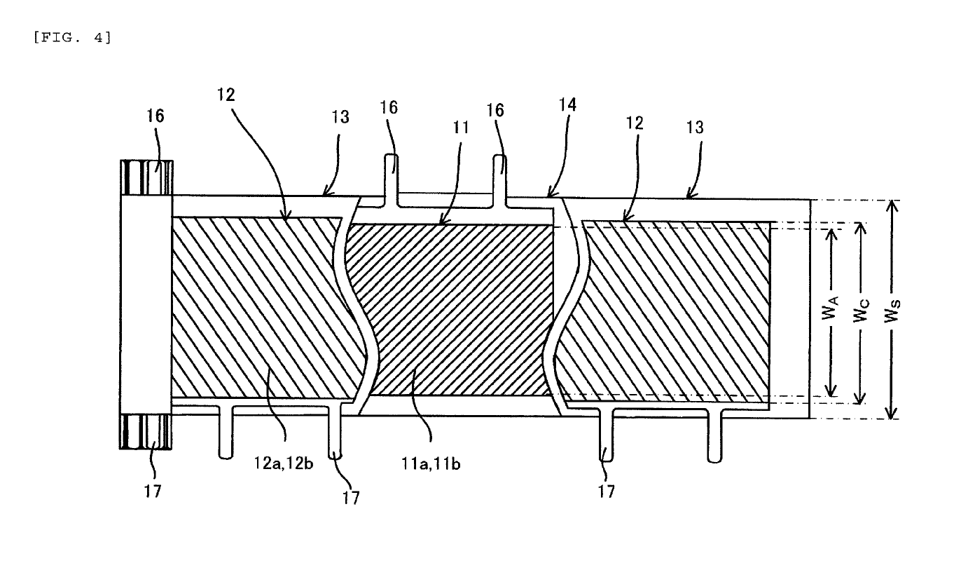

Reference numeral 10 denotes an electrode group having an axial core 15 in a center portion thereof, and a positive electrodes, a negative electrode, and separators are wound around the axial core 15. FIG. 3 is a perspective view illustrating the detailed structure of the electrode group 10 which is partially cut. Also, FIG. 4 is a plan view of a state in which the positive and negative electrodes and the separators in the electrode group illustrated in FIG. 3 are partially developed.

As illustrated in FIG. 3, the electrode group 10 has a structure in which a positive electrode 11, a negative electrode 12, and first and second separators 13, 14 are wound around the axial core 15.

The axial core 15 has a hollow cylindrical shape, and the negative electrode 12, the first separator 13, the positive electrode 11, and the second separator 14 are stacked on the axial core 15 in the stated order, and wound thereon. The first separator 13 and the second separator 14 are wound on the inside of the innermost peripheral negative electrode 12 by several turns (one turn in FIG. 3). The negative electrode 12 and the first separator 13 wound on an outer periphery of the negative electrode 12 are formed in the stated order in the outermost periphery of the electrode group 10 (refer to FIGS. 3 and 4). The outermost peripheral first separator 13 is retained by an adhesive tape 19 (refer to FIG. 2).

In FIG. 4, middle portions of the negative electrode 12 and the first separator 13 are cut, and the positive electrode 11 and the second separator 14 are exposed from this cut portion.

The positive electrode 11 has an elongated shape formed of an aluminum foil, and includes a positive electrode processed part having a positive electrode metal foil (metal foil) 11a, and positive electrode mix layers 11b formed on both surfaces of the positive electrode metal foil 11a. One side edge on an upper side along the longitudinal direction of the positive electrode metal foil 11a is formed with a positive electrode mix unprocessed portion 11c from which the aluminum foil is exposed without being formed with the positive electrode mix layers 11b. A large number of positive electrode leads 16 protruded upward from the positive electrode mix unprocessed portion 11c in parallel to the axial core 15 are integrally formed at regular intervals.

The positive electrode mix includes a positive electrode active material, a positive electrode conductive material, and a positive electrode binder. The positive electrode active material is preferably a lithium metal oxide or a lithium transition metal oxide. As an example, the positive electrode active material is exemplified by lithium cobalt oxide, lithium manganese oxide, lithium nickel oxide, and lithium complex metal oxide (including transition metal oxide of lithium including two or more kinds selected from cobalt, nickel, and manganese). The positive electrode conductive material is not particularly limited if the positive electrode conductive material can assist transmission of electrons generated by the storage/discharge reaction of lithium in the positive electrode mix to the positive electrode. Since the above lithium complex metal oxide including transition metal has a conductive property, this material per se may be used as the positive electrode conductive material. However, in particular, excellent characteristics are obtained by using the lithium transition metal complex oxide including the lithium cobalt oxide, lithium manganese oxide, and lithium nickel oxide, which are the above-mentioned materials.

The positive electrode binder can bind the positive electrode active material to the positive electrode conductive material, and also bind the positive electrode mix layers 11b to the positive electrode metal foil 11a, and is not particularly limited if the positive electrode binder is not remarkably deteriorated by a contact with nonaqueous electrolyte. The positive electrode binder is exemplified by polyvinylidene fluoride (PVDF) and fluorine contained rubber. A method of forming the positive electrode mix layers 11b is not limited if there is applied a method of forming the positive electrode mix layers 11b on the positive electrode metal foil 11a. The method of forming the positive electrode mix layers 11b is exemplified by a method of coating a disperse solution of a constituent material of the positive electrode mix on the positive electrode metal foil 11a.

The method of forming the positive electrode mix layers 11b on the positive electrode metal foil 11a is exemplified by a roll coating method and a slit die coating method. An N-methylpyrrolidone (NMP) or water is added as a solvent example of the disperse solution to the positive electrode mix, kneaded slurry is uniformly coated on both surfaces of the aluminum foil 20 μm in thickness, and dried. Thereafter, the aluminum foil is cut by a die cut. A coating thickness of the positive electrode mix is exemplified by about 40 μm on each side. When the positive electrode metal foil 11a is cut, the positive electrode leads 16 are integrally formed. Lengths of all the positive electrode leads 16 are substantially equal to each other. After the positive electrode leads 16 have been formed by cutting, the positive electrode mix is thermally pressed by a press roll, and contact areas between particles of the positive electrode mix, and between the particles and the positive electrode metal foil 11a are increased to reduce a DC resistance. Also, since the thickness of the positive electrode mix layers 11b is reduced by the hot pressing, when the electrode group 10 having the same diameter is formed, a length of the positive electrode mix layers 11b can be increased to increase a battery capacity.

A specified method for forming the positive electrode 11 will be described later.

The negative electrode 12 has an elongated shape formed of a copper foil, and includes a negative electrode processed part having a negative electrode metal foil 12a, and negative electrode mix layers 12b formed on both surfaces of the negative electrode metal foil 12a. A side edge on a lower side along the longitudinal direction of the negative electrode metal foil 12a is formed with a negative electrode mix unprocessed portion 12c from which the copper foil is exposed without being formed with the negative electrode mix layers 12b. A large number of negative electrode leads 17 protruded from the negative electrode mix unprocessed portion 12c in a direction opposite to the positive electrode leads 16 are integrally formed at regular intervals. With this structure, a current can be substantially equally dispersed to flow, thereby leading to an improvement in the reliability of the lithium ion secondary battery.

The negative electrode mix layers 12b includes a negative electrode active material, a positive electrode binder, and a thickening agent. The negative electrode mix may include a negative electrode conductive material such as acetylene black. The negative electrode active material is preferably graphite carbon, particularly artificial graphite. However, particularly, the negative electrode mix layers 12b having the excellent characteristics are obtained by a method described below. The lithium ion secondary battery intended for plug-in hybrid vehicles and electric vehicles requiring a large capacity can be fabricated by using carbon graphite. The method of forming the negative electrode mix layers 12b is not limited if there is applied a method of forming the negative electrode mix layers 12b on the negative electrode metal foil 12a. The method of coating the negative electrode mix on the negative electrode metal foil 12a is exemplified by a method of coating a disperse solution of a constituent material of the negative electrode mix on the negative electrode metal foil 12a. The coating method is exemplified by the roll coating method and the slit die coating method.

The method of forming the negative electrode mix layers 12b on the negative electrode metal foil 12a is exemplified by adding N-methyl-2-pyrolidone and water to the negative electrode mix as a disperse solvent, uniformly coating kneaded slurry on both surfaces of a rolled copper foil 10 μm in thickness, drying the copper foil, and thereafter cutting the copper foil. A coating thickness of the negative electrode mix is exemplified by about 40 μm on each side. When the negative electrode metal foil 12a is cut, the negative electrode leads 17 are integrally formed. Lengths of all the negative electrode leads 17 are substantially equal to each other. After the negative electrode leads 17 have been formed by cutting, the negative electrode mix is thermally pressed by a press roll, and contact areas between particles of the negative electrode mix, and between the particles and the negative electrode metal foil 12a are increased to reduce a DC resistance. Also, since the thickness of the negative electrode mix layers 12b is reduced by the hot pressing, when the electrode group 10 having the same diameter is formed, a length of the negative electrode mix layers 12b can be increased to increase a battery capacity.

A width Wₛ of the first separator 13 and the second separator 14 is set to be larger than a width W_{c} of the negative electrode mix layers 12b formed on the negative electrode metal foil 12a. Also, the width W_{c} of the negative electrode mix layers 12b formed on the negative electrode metal foil 12a is set to be larger than a width W_{A} of the positive electrode mix layers 11b formed on the positive electrode metal foil 11a.

Since the width W_{c} of the negative electrode mix layers 12b is larger than the width W_{A} of the positive electrode mix layers 11b, internal short-circuiting by deposition of a foreign matter is prevented. This is because in the case of the lithium ion secondary battery, although lithium that is the positive electrode active material is ionized to penetrate through the separator, the negative electrode mix layers 12b are not formed on the negative electrode metal foil 12a side, and if the negative electrode metal foil 12a is exposed from the positive electrode mix layers 11b, lithium is deposited on the negative electrode metal foil 12a to generate the internal short-circuiting.

The first and second separators 13 and 14 are each formed of a polyethylene porous membrane, for example, 40 μm in thickness.

In FIGS. 1 and 3, the axial core 15 having the hollow cylindrical shape has a step 15a having a diameter larger than an inner diameter of the axial core 15 formed on an inner surface of an upper end portion thereof in the axial direction (vertical direction in the drawing), and a positive electrode current collector member 27 is fitted into the step 15a.

The positive electrode current collector member 27 is made of, for example, aluminum, and includes a disc-shaped base 27a, a lower cylindrical portion 27b that is protruded toward the axial core 15 side in an inner peripheral portion of a surface facing to the electrode group 10 of the base 27a and fitted into an inner surface of the step 15a of the axial core 15, and an upper cylindrical portion 27c protruded toward the battery cap 3 side in an outer peripheral edge. Opening portions 27d (refer to FIG. 2) for discharging gas generated within the battery by overcharging are formed in the base 27a of the positive electrode current collector member 27. Also, an opening portion 27e is formed in the positive electrode current collector member 27, and a function of the opening portion 27e will be described later. The axial core 15 is made of a material that is electrically insulated from a positive electrode current collector member 31 and the a negative electrode current collector member 21, and enhances the rigidity of the battery in the axial direction. In this embodiment, the axial core 15 is made of, for example, a fiberglass-reinforced polypropylene.

All the positive electrode leads 16 of the positive electrode metal foil 11a are welded to the upper cylindrical portion 27c of the positive electrode current collector member 27. In this case, as illustrated in FIG. 2, the positive electrode leads 16 overlap with each other on the upper cylindrical portion 27c of the positive electrode current collector member 27, and are joined together. Because the respective positive electrode leads 16 are very thin, a large current cannot be extracted by one positive lead 16. For that reason, a large number of positive electrode leads 16 are formed at given intervals over an overall length of the positive electrode metal foil 11a wound from a winding start to a winding end around the axial core 15.

The positive electrode leads 16 of the positive electrode metal foil 11a and a retainer member 28 are welded onto an outer periphery of the upper cylindrical portion 27c of the positive electrode current collector member 27. The large number of positive electrode leads 16 is brought in close contact with the outer periphery of the upper cylindrical portion 27c of the positive electrode current collector member 27 in advance, the retainer member 28 is wound on the outer periphery of the positive electrode leads 16 in a ring shape, provisionally fixed thereto, and welded thereto in this state.

An outer periphery of the lower end portion of the axial core 15 is formed with a step 15b having an outer diameter smaller than an outer shape of the axial core 15, and the negative electrode current collector member 21 is pressed into the step 15b and fixed. The negative electrode current collector member 21 is made of, for example, copper smaller in resistance value, an opening portion 21b fitted into the step 15b of the axial core 15 is formed in a disc-shaped base 21a, and an outer peripheral cylinder 21c that protruded toward a bottom side of the battery can 2 is formed on an outer peripheral edge.

All of negative electrode leads 17 of the negative electrode metal foil 12a are welded to the outer peripheral cylinder 21c of the negative electrode current collector member 21 by ultrasonic welding. Because the respective negative electrode leads 17 are very thin, in order to extract a large current, a large number of negative electrode leads 17 are formed at given intervals over an overall length of the negative electrode metal foil 12a wound from a winding start to a winding end around the axial core 15.

The negative electrode leads 17 of the negative electrode metal foil 12a and a retainer member 22 are welded to an outer periphery of the outer peripheral cylinder 21c of the negative electrode current collector member 21. The large number of negative electrode leads 17 is brought in close contact with the outer periphery of the outer peripheral cylindrical portion 21c of the negative electrode current collector member 21 in advance, the retainer member 22 is wound on the outer periphery of the negative electrode leads 17 in a ring shape, provisionally fixed thereto, and welded thereto in this state.

A lower surface of the negative electrode, current collector member 21 is welded to a negative electrode energization lead 23 made of nickel.

The negative electrode energization lead 23 is welded to the battery can 2 on the bottom of the battery can 2 made of iron.

The opening portion 27e formed in the positive electrode current collector member 27 is designed to allow an electrode bar (not shown) for welding the negative electrode energization lead 23 to the battery can 2 to insert thereinto. The electrode bar is inserted into the hollow portion of the axial core 15 from the opening portion 27e formed in the positive electrode current collector member 27, and the negative electrode energization lead 23 is pushed against the bottom inner surface of the battery can 2 by a tip portion thereof to conduct resistance welding. The battery can 2 connected to the negative electrode current collector member functions as one output terminal of the cylindrical secondary battery 1, and can extract an electric power stored in the electrode group 10 from the battery can 2.

The large number of positive electrode leads 16 are welded to the positive electrode current collector member 27, and the large number of negative electrode leads 17 are welded to the negative electrode current collector member 21 to configure a power generation unit 20 in which the positive electrode current collector member 27, the negative electrode current collector member 21, and the electrode group 10 are unitized integrally (refer to FIG. 2). In FIG. 2, for convenience of illustration, the negative electrode current collector member 21, the retainer member 22, and the negative electrode energization lead 23 are illustrated separately from the power generation unit 20.

Also, a flexible connection member 33 configured by stacking a plurality of aluminum foils has one end welded onto, and joined to an upper surface of the base 27a of the positive electrode current collector member 27. The connection member 33 is integrated by stacking a plurality of aluminum foils to enable a large current to flow thereinto, and also to provide a flexibility.

A ring-shaped insulating plate 34 made of an insulating resin material having a circular opening portion 34a is arranged on the upper cylindrical portion 27c of the positive electrode current collector member 27.

The insulating plate 34 has the opening portion 34a (refer to FIG. 2), and a side portion 34b protruded downward. A connection plate 35 is fitted into the opening portion 34a of the insulating plate 34. The other end of the flexible connection member 33 is welded to a lower surface of the connection plate 35, and fixed thereto.

The connection plate 35 is made of aluminum alloy, and has a substantially plate shape in which the substantially entirety is uniform except for the center portion, and the center side is bent to a slightly lower position. A protrusion 35a that is thinned and formed into a domical shape is formed in the center of the connection plate 35, and a plurality of opening portions 35b (refer to FIG. 2) is formed around the protrusion 35a. The opening portions 35b have a function of discharging the gas generated within the battery by overcharging.

The protrusion 35a of the connection plate 35 is joined to the bottom surface of the center portion of a diaphragm 37 by resistance welding or friction diffusion welding. The diaphragm 37 is made of aluminum alloy, and has a circular notch 37a centered on a center portion of the diaphragm 37. The notch 37a has an upper surface side crushed into a V- or U-shape by pressing, and the remaining portion is thinned.

The diaphragm 37 is disposed for ensuring the safety of the battery, and when a pressure of the gas generated within the battery is raised, the diaphragm 37 is warped upward as a first stage, and the joint of the diaphragm 37 to the protrusion 35a of the connection plate 35 is broken and separated from the connection plate 35 to break a conduction with the connection plate 35. As a second stage, the diaphragm 37 has a function of tearing at the notch 37a, discharging the gas within the battery, and dropping the internal pressure, when the internal pressure in the battery is still raised.

The diaphragm 37 fixes a peripheral edge 3a of the battery cap 3 to a peripheral edge thereof. As illustrated in FIG. 2, the diaphragm 37 initially has a side portion 37b vertically erected toward the battery cap 3 side on the peripheral edge thereof. The battery cap 3 is accommodated within the side portion 37b, and the side portion 37b is bent toward the upper surface side of the battery cap 3, and fixed thereto by caulking.

The battery cap 3 is made of iron such as carbon steel, and has an overall surface of the outside and the inside formed with a plating layer made of nickel. The battery cap 3 has a hat shape having a disc-shaped peripheral edge 3a that comes in contact with the diaphragm 37, and a closed topped and open-bottomed cylindrical portion 3b protruded upward from the peripheral edge 3a. An opening portion 3c is formed in the cylindrical portion 3b. The opening portion 3c is designed to discharge the gas out of the battery when the diaphragm 37 tears due to the gas pressure generated within the battery.

The battery cap 3, the diaphragm 37, the insulating plate 34, and the connection plate 35 are integrated into a battery cap unit 30.

As described above, the connection plate 35 of the battery cap unit 30 is connected to the positive electrode current collector member 27 by the connection member 33. Therefore, the battery cap 3 is connected to the positive electrode current collector member 27. In this way, the battery cap 3 connected to the positive electrode current collector member 27 operates as the other output terminal, and the electric power stored in the electrode group 10 can be output by the battery cap 3 that operates as the other output terminal, and the battery can 2 that functions as one output terminal.

The seal member 43 generally called “gasket” is disposed to cover the peripheral edge of the side portion 37b of the diaphragm 37. The seal member 43 is made of rubber, and can be made of fluorine contained resin as one preferable material example although being not intended for limitation.

As illustrated in FIG. 2, the seal member 43 is initially shaped to have an outer peripheral wall portion 43b substantially vertically erected toward the upper direction on the peripheral edge of a ring-shaped base 43a.

The outer peripheral wall portion 43b of the seal member 43 is bent together with the battery can 2 by pressing so that the diaphragm 37 and the battery cap 3 are crimped in the axial direction by the base 43a and the outer peripheral wall portion 43b by caulking. With this processing, the battery cap unit 30 into which the battery cap 3, the diaphragm 37, the insulating plate 34, and the connection plate 35 are integrally formed is fixed to the battery can 2 through the seal member 43.

A given amount of nonaqueous electrolyte 6 is poured into the battery can 2. The nonaqueous electrolyte 6 is preferably exemplified by solution in which lithium salt is solved in a carbonate solvent. Lithium salt is exemplified by lithium hexafluorophosphate (LiPF₆) and lithium tetrafluoroborate (LiBF₄) Also, the carbonate solvent is exemplified by ethylene carbonate (EC), dimethyl carbonate (DMC), propylene carbonate (PC), methyl ethyl carbonate (MEC), or a mixture of the solvents selected from two or more kinds of the above solvents.

### (Method of Manufacturing Positive Electrode)

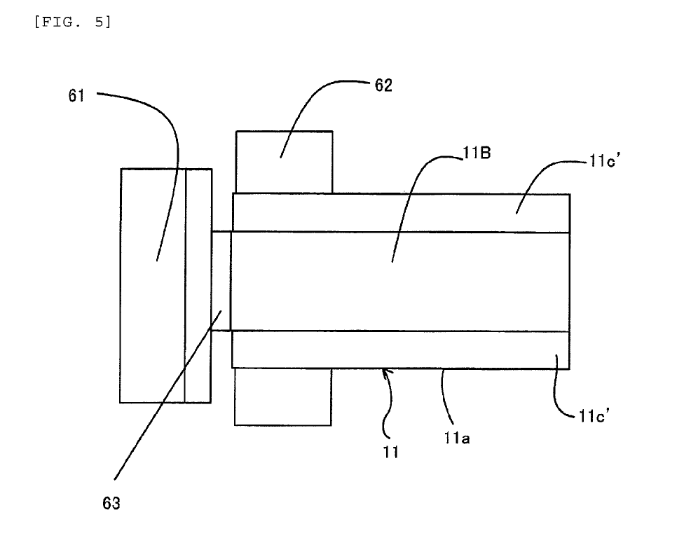

Subsequently, a method of forming the positive electrode will be described with reference to FIGS. 5 to 9.

FIG. 5 is a plan view illustrating a method of forming the positive electrode mix layers 11b on the positive electrode metal foil 11a. The following description is applied to a case of taking two sheets in which two sheets of positive electrodes 11 is formed from a single positive electrode metal foil 11A. That is, the positive electrode metal foil 11A has a width twice or more as large as a width of the single positive electrode metal foil 11a, and as will be described later, a center portion in the width direction is cut along the longitudinal direction to obtain two positive electrodes 11.

The positive electrode active material, the positive electrode conductive material, and the positive electrode binder are kneaded, for example, with the use of a planetary mixer to form a positive electrode mix slurry 63. The positive electrode active material, the positive electrode conductive material, and the positive electrode binder are made of the above-mentioned materials.

The positive electrode metal foil 11A is made of aluminum alloy, and one end thereof is pulled from a winding roller (not shown), and wound on a backup roller 62. Then, the one end pulled from the winding roller is wound on a take-up roller (not shown) in advance.

Subsequently, the positive electrode mix slurry 63 is coated on the positive electrode metal foil 11A. In this description, the coating method is exemplified by a slit die coating method.

The positive electrode mix slurry 63 is fed to a die head 61 having a slit of a given width, and the positive electrode mix slurry 63 is ejected from the slit of the die head 61 over a surface of the positive electrode metal foil 11A while transferring the positive electrode metal foil 11A by a feed roller not shown, and the positive electrode mix slurry 63 is coated in a center area of the positive electrode metal foil 11A.

In this case, a width of a positive electrode mix layers 11B coated on the positive electrode metal foil 11A has a size twice or more as large as the width of the positive electrode mix layers 11b of the single positive electrode 11. Also, both side edges of the positive electrode mix layers 11B along the longitudinal direction are each formed with a positive electrode mix unprocessed portion 11c′ having a width larger than the width of the positive electrode mix unprocessed portion 11c of the single positive electrode 11. The positive electrode mix unprocessed portions 11c′ are areas in which the positive electrode mix is not coated, and aluminum alloy which is a material of the positive electrode metal foil 11A is exposed. In this stage, the positive electrode leads 16 are not formed in the positive electrode mix unprocessed portions 11c′.

After the positive electrode mix layers 11B are coated on both surfaces of the positive electrode metal foil 11A, the positive electrode metal foil 11A is inserted into a hot-air drying path, and dried at a temperature of 100 to 150° C.

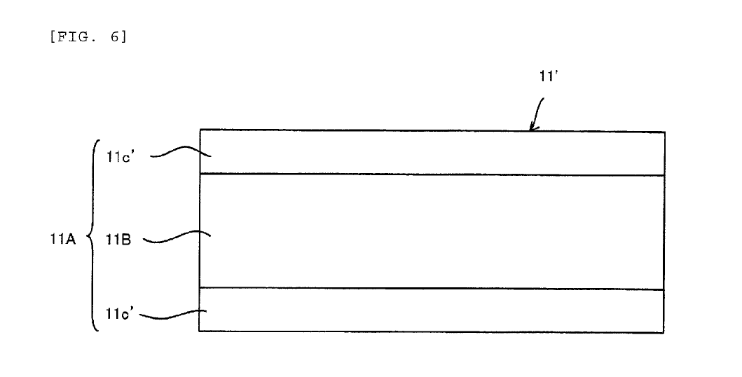

FIG. 6 is a plan view illustrating the positive electrode 11′ having the Positive electrode mix layers 11B in a state where drying has been completed. As described above, the positive electrode 11′ is formed with a positive electrode mix layer 11B having a size twice or more as large as the width of the positive electrode mix layers 11b of the single positive electrode 11 in a center area thereof, and positive electrode mix unprocessed portions 11c′ each having a width larger than the width of the positive electrode mix unprocessed portion 11c on both side edges of the positive electrode mix layer 11B along the longitudinal direction thereof.

After the positive electrode mix layer 11B is coated over a surface of the positive electrode metal foil 11A, and dried, the positive electrode mix layer 113 is coated on the other surface of the positive electrode metal foil 11A, and dried as in the above-mentioned process.

Subsequently, the positive electrode leads 16 are formed on both side edges of the positive electrode 11.

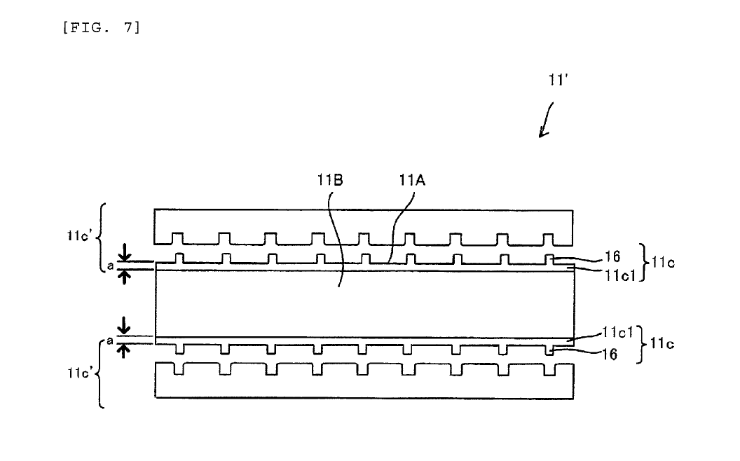

FIG. 7 is a plan view illustrating a method of forming the positive electrode leads 16.

For example, with the use of a die cut machine, the positive electrode mix unprocessed portion 11c having a large number of positive electrode leads 16 is formed on each of the positive electrode mix unprocessed portions 11c′ formed on both sides of the positive electrode metal foil 11A. In this case, each of the positive electrode mix unprocessed portions 11c is subjected to die cut so as to be configured by a continuous area portion 11c1 having the width a and continuous along the longitudinal direction of the positive electrode metal foil 11A, and the positive electrode leads 16 extended from the continuous area portion 11c1 in a direction perpendicular to the longitudinal direction.

As illustrated in FIG. 7, after the positive electrode mix unprocessed portion 11c configured by the positive electrode leads 16 and the continuous area portion 11c1 has been formed on the positive electrode metal foil 11A, the positive electrode metal foil 11A is thermally pressed, and the positive electrode mix is dried.

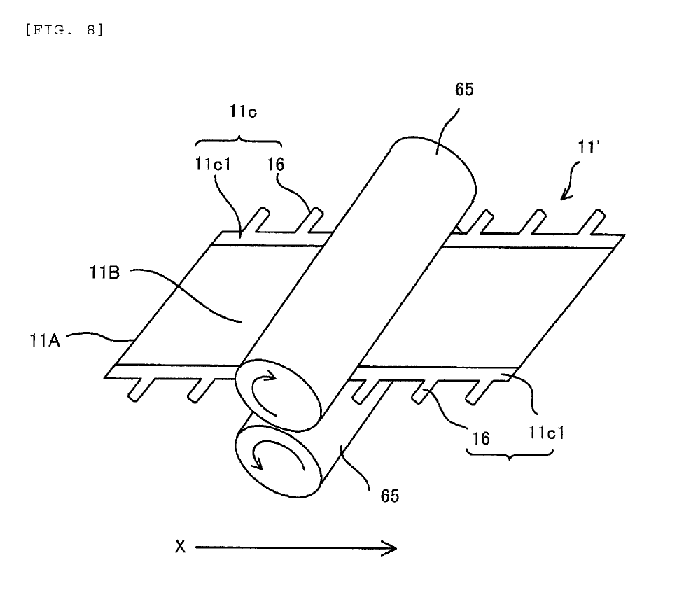

The heat press is conducted by, for example, a hot pressing roll as illustrated in FIG. 8. In this method, with the use of a pair of rollers 65 having a temperature raised to 100 to 120° C., the respective rollers 65 are rotated in a direction shown with respect to a transfer direction X of the positive electrode 11′.

The solvent contained in the positive electrode mix is evaporated due to drying after the above coating process, and voids formed in the positive electrode mix layer 11B are reduced. Also, with a pressure at the time of hot pressing, a contact area between the respective particles of the positive electrode active material, and a contact area between the positive electrode metal foil 11A and the particles of the positive electrode active material are increased, and a DC resistance of the battery is reduced. Further, with the hot pressing, a ratio of the positive electrode mix per volume is increased, and a volume of the positive electrode mix layers 11B in the overall electrode group 10 is increased, as result of which the battery capacity is also increased. With this hot pressing, a thickness of the positive electrode mix layer 11B is compressed to 60 to 80% of that before being pressed (a value including no thickness of the positive electrode metal foil 11A).

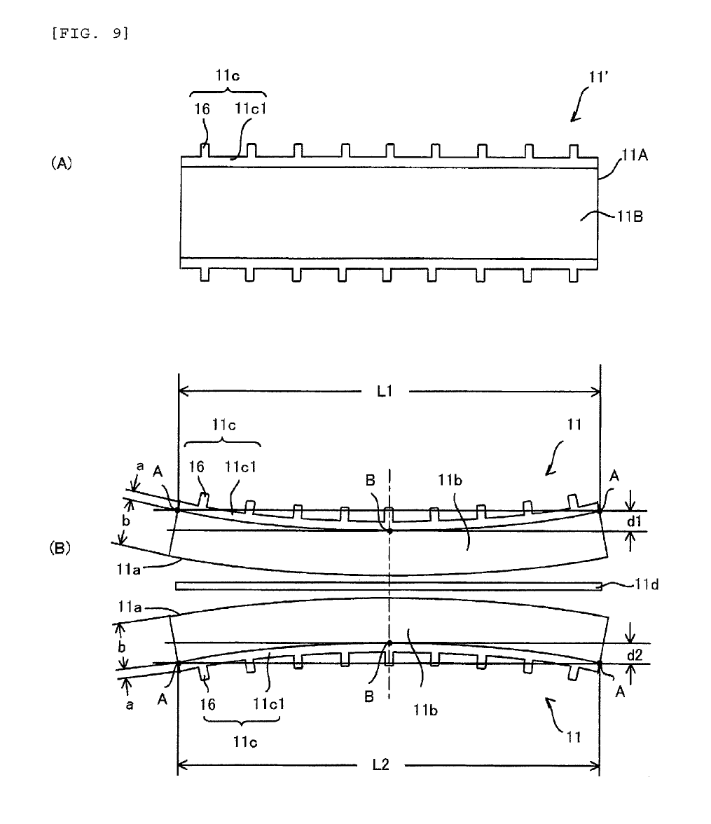

FIG. 9(A) is a plan view of the positive electrode 11′ in a state where the hot pressing has been completed.

After the positive electrode 11′ has been brought into a state of FIG. 9(A), the positive electrode 11′ is cut along the longitudinal direction in the center portion in the width direction, a metal piece 11d is formed in the center portion, and divided into three pieces so as to obtain the respective positive electrodes 11 on both sides of the metal piece 11d.

In this case, the metal piece 11d in the center portion is arranged to adjust misalignment when the positive electrodes 11 are formed on both sides thereof. With the provision of this portion, a yield is improved, and the productivity is also improved.

Thus, when the positive electrode 11′ is cut along the longitudinal direction, and separated, as illustrated in FIG. 9(B), each of the positive electrodes 11 is curved into a fan shape having the positive electrode mix unprocessed portion 11c side as an inner peripheral side, and the positive electrode mix layers 11b as an outer peripheral side. The degree of curvature is compared with a parameter called “the degree of fan”.

In the present invention, the degree of fan is defined as follows with reference to FIG. 9(B).

It is assumed that the degree of fan is a length d1 (d2) between a line connecting portions A on both side ends of the positive electrode mix layer 11b on the innermost peripheral side to each other, and a line passing a portion B (normally, positioned on a center line of the fan shape) positioned on the outermost peripheral side of the positive electrode mix layer 11b, in the vertical direction, in a state where the positive electrode 11 is curved into the fan shape having the positive electrode mix unprocessed portion 11c side as an inside.

In the above description, in this embodiment, the degree of fan is expressed by the length d1 (d2) with a unit mm when the lengths L1 and L2 of the positive electrodes 11 are each 1 m. If the lengths of the positive electrodes 11 satisfy L1=L2 (=L), d1=d2 (=d) is satisfied.

As will become apparent from the following description, the degree of fan d is changed a ratio (a/b) of a width a (that is, including no length of the positive electrode lead 16) of the continuous area portion 11c1 in the positive electrode mix unprocessed portion 11c, and a width b of the positive electrode mix layer 11b, and the degree of fan d tends to be smaller as (a/b) is smaller.

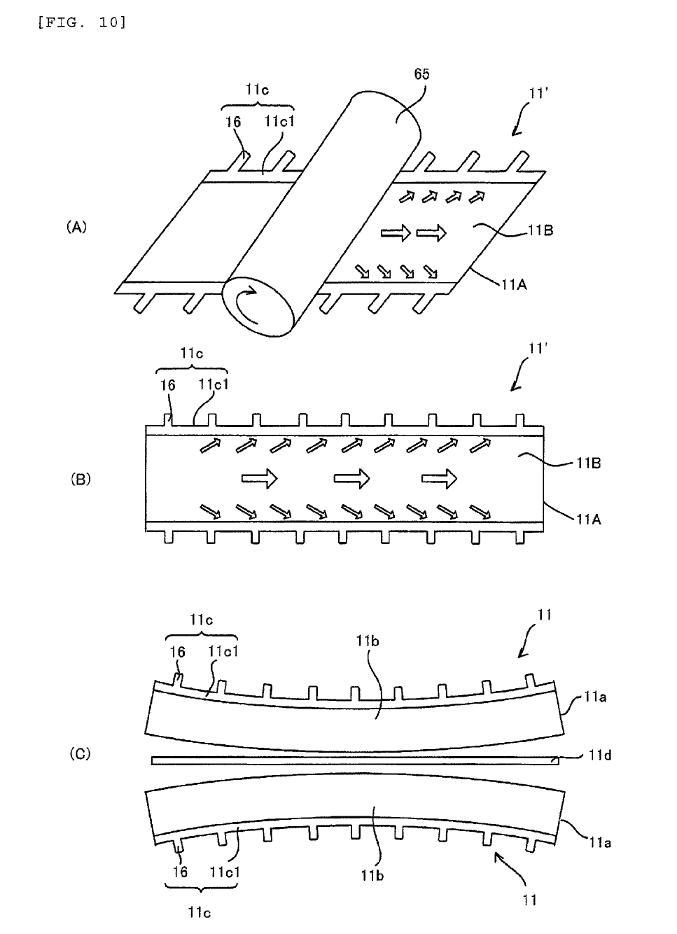

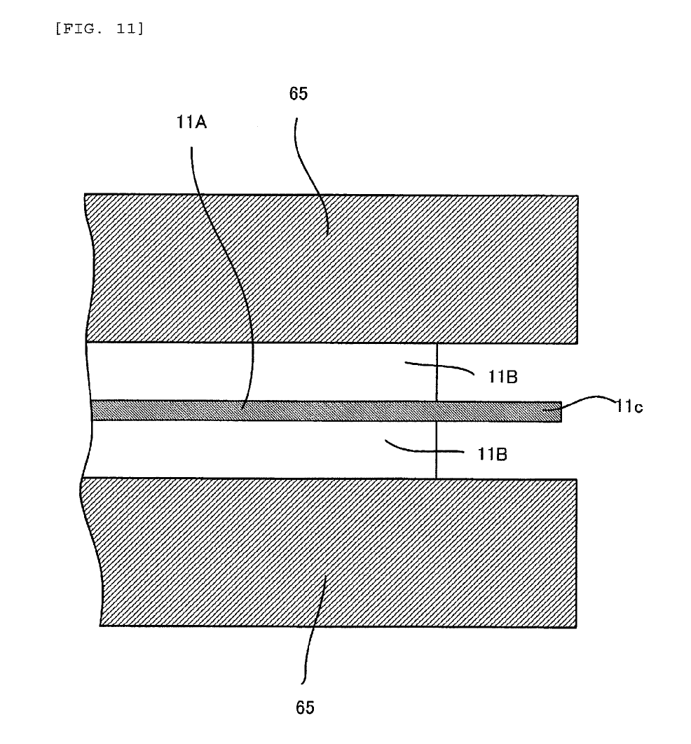

A reason that the positive electrode 11 is curved into the fan shape having the positive electrode mix unprocessed portion 11c side as the inside will be described with reference to FIGS. 10 and 11.

As illustrated in FIG. 8, in a process in which the positive electrode mix layer 11B of the positive electrode 11′ is subjected to the hot roll pressing, the positive electrode metal foil 11A has an area which is pressurized by the rollers 65 through the positive electrode mix layers 11b, and an area which is not pressured.

FIG. 11 is a partially enlarged cross-sectional view of FIG. 5.

Areas of the respective positive electrode metal foils 11A immediately below the positive electrode mix layers 11B are subject to a pressure of the rollers 65 through the positive electrode mix layers 11B because the rollers 65 come in contact with upper surfaces of the positive electrode mix layers 11B. On the other hand, an area of the positive electrode mix unprocessed portion 11c of the positive electrode metal foil 11A is not subject to the pressure of the rollers 65.

For that reason, as indicated by outline arrows in FIGS. 10(A) and (B), a residual stress urged toward a side edge direction along the rolling direction from the center portion in the width direction is exerted on the positive electrode metal foil 11A together with the rotation of the rollers 65. On the other hand, because no residual stress is not exerted on the positive electrode mix unprocessed portion 11c, a difference in the residual stress is maximum on a boundary between the positive electrode mix layer 11B and the positive electrode mix unprocessed portion 11c. For that reason, an action is exerted on the positive electrode metal foil 11A to be bent into the fan shape having the positive electrode mix unprocessed portion 11c side as the inner peripheral side, and the positive electrode mix layer 11B side as the outer peripheral side.

Therefore, as illustrated in FIG. 10(C), when the positive electrode 11′ is divided into three sheets so that the positive electrodes 11 are formed on both sides of the metal piece 11d in the center portion, the stress is unbalanced, and the respective positive electrodes 11 is curved into the fan shape having the positive electrode mix unprocessed portion 11c side as the inner peripheral side, and the positive electrode mix layers 11B side as the outer peripheral side as illustrated in the figure.

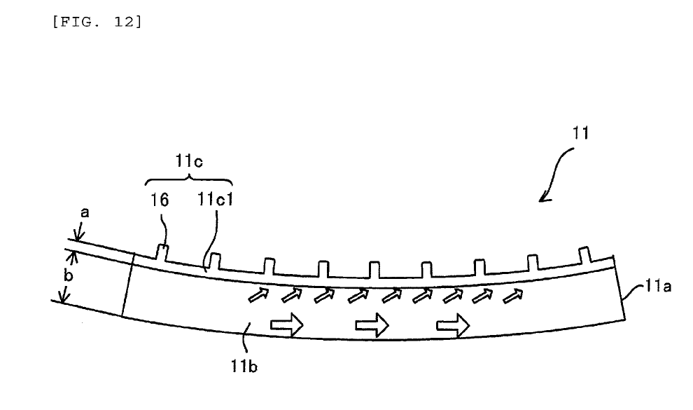

FIG. 12 is a plan view when the positive electrode 11 is formed with the positive electrode mix layers 11b and the positive electrode mix unprocessed portion 11c as a size for taking a single sheet. In this case, the positive electrode mix unprocessed portion 11c is formed only on one side edge of the positive electrode metal foil 11a, and a boundary between an area of the positive electrode metal foil 11a in which a residual stress remains, and the positive electrode mix unprocessed portion 11c in which the residual stress does not remain is present only on one side edge of the positive electrode metal foil 11a. Therefore, the residual stress generated along the rolling direction from the center portion in the width direction together with the rotation of the rollers 65 causes an action to curve the positive electrode 11 into the fan shape having the positive electrode mix unprocessed portion 11c side on one side edge as the inner peripheral side, and the positive electrode mix layer 11b side as the outer peripheral side. For that reason, the hot roll pressing is advanced, and the temperature of the positive electrode mix layer 11b drops. Also, the positive electrode metal foil 11a is curved into the fan shape having the positive electrode mix unprocessed portion 11c side as the inner peripheral side, and the positive electrode mix layer 11b side as the outer peripheral side.

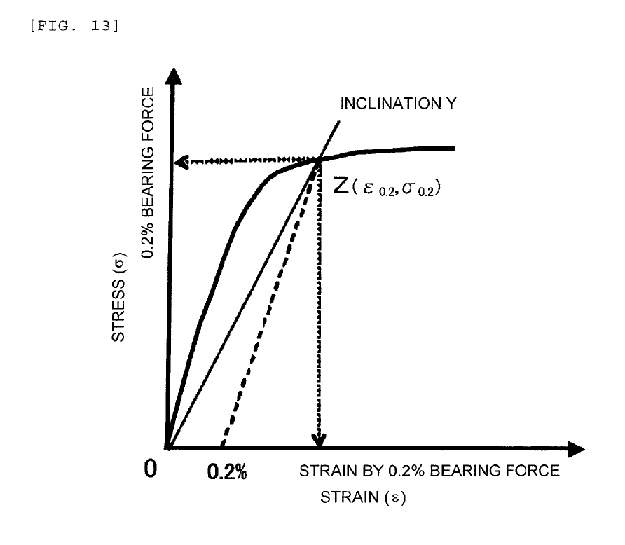

FIG. 13 is a diagram illustrating a method of obtaining an inclination Y from a stress-strain characteristic curve in the aluminum alloy.

A specimen made of aluminum alloy having given dimensions (for example, 100 mm length×10 mm width) is subject to a tensile force, for example, by a universal testing machine. The tensile force is gradually increased, and the specimen is strained until the specimen is broken. In this situation, a stress (σ) and the strain (ε) are measured, and a stress (σ)-strain (ε) characteristic curve is drawn as indicated by a thick solid line in FIG. 13.

A line (dotted line in FIG. 13) parallel to an area close to a base of the stress (σ)-strain (ε) characteristic curve is drawn from a point where the strain (ε) is 0.2%, and a cross point Z (ε_{0.2}, σ_{0.2}) between the line and the stress (σ)-strain (ε) characteristic curve is obtained. In this situation, the stress σ_{0.2} is 0.2% bearing force, and the strain ε_{0.2} is a strain with the 0.2% bearing force.

The point Z (ε_{0.2}, σ_{0.2}) and an origin (strain ε=0, stress σ=0) are connected by a line as indicated by a thin solid line in FIG. 13, and an inclination of this line is set as Y.

### Example 1

With the use of aluminum alloy containing Mn of 1% as the positive electrode metal foil 11a, the positive electrode 11 with (a/b)=0.025 which is a ratio of the width a of the continuous area portion 11c1 in the positive electrode mix unprocessed portion 11c, and the width b of the positive electrode mix layer 11b is fabricated. The 0.2% bearing force of the aluminum alloy is 246 MPa, and the strain at the 0.2% bearing force is 0.0067. Also, the inclination Y is 36.7 GPa.

The degree of fan d after the positive electrode mix layers 11b of the positive electrode 11 has been pressurized by the hot pressing roll is 1 mm. In this case, as described above, the degree of fan d is the amount of deformation when the length L of the positive electrode metal foil 11a is 1 m. In the following description, the degree of fan d is the amount of deformation when the length L of the positive electrode metal foil 11a is 1 m.

### Example 2

As with the example 1, with the use of aluminum alloy which are 246 MPa in 0.2% bearing force, 0.0067 in the strain at the 0.2% bearing force, and 36.7 GPa in the inclination Y, the positive electrode 11 with (a/b)=0.040 which is the ratio of the width a of the continuous area portion 11c1 in the positive electrode mix unprocessed portion 11c, and the width b of the positive electrode mix layer 11b is fabricated.

The degree of fan d after the positive electrode mix layers 11b of the positive electrode 11 has been pressurized by the hot pressing roll is 2 mm.

### Example 3

As with the example 1, with the use of aluminum alloy which are 246 MPa in 0.2% bearing force, 0.0067 in the strain at the 0.2% bearing force, and 36.7 GPa in the inclination Y, the positive electrode 11 with (a/b)=0.070 which is the ratio of the width a of the continuous area portion 11c1 in the positive electrode mix unprocessed portion 11c, and the width b of the positive electrode mix layer 11b is fabricated.

The degree of fan d after the positive electrode mix layers 11b of the positive electrode 11 has been pressurized by the hot pressing roll is 2 mm.

### Example 4

As with the example 1, with the use of aluminum alloy which are 246 MPa in 0.2% bearing force, 0.0067 in the strain at the 0.2% bearing force, and 36.7 GPa in the inclination Y, the positive electrode 11 with (a/b)=0.090 which is the ratio of the width a of the continuous area portion 11c1 in the positive electrode mix unprocessed portion 11c, and the width b of the positive electrode mix layer 11b is fabricated.

The degree of fan d after the positive electrode mix layers 11b of the positive electrode 11 has been pressurized by the hot pressing roll is 2 mm.

### Example 5

With the use of aluminum alloy containing Mn of 1% as the positive electrode metal foil 11a, the positive electrode 11 with (a/b)=0.040 which is a ratio of the width a of the continuous area portion 11c1 in the positive electrode mix unprocessed portion 11c, and the width b of the positive electrode mix layer 11b is fabricated. The 0.2% bearing force of the aluminum alloy is 218 MPa, and the strain at the 0.2% bearing force is 0.0061. Also, the inclination Y is 35.7 GPa.

The degree of fan d after the positive electrode mix layers 11b of the positive electrode 11 has been pressurized by the hot pressing roll is 2 mm.

### Comparative Example

As with the example 5, with the use of aluminum alloy which are 218 MPa in 0.2% bearing force, 0.0061 in the strain at the 0.2% bearing force, and 35.7 GPa in the inclination Y, the positive electrode 11 with (a/b)=0.090 which is the ratio of the width a of the continuous area portion 11c1 in the positive electrode mix unprocessed portion 11c, and the width b of the positive electrode mix layer 11b is fabricated.

The degree of fan d after the positive electrode mix layers 11b of the positive electrode 11 has been pressurized by the hot pressing roll is 6 mm.

### (Confirmation of Advantageous Effects]

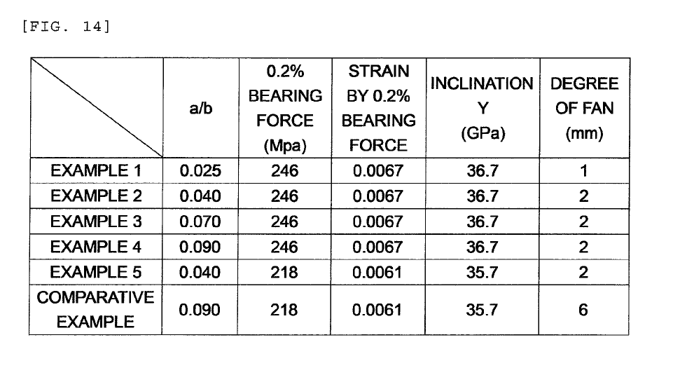

The measurement results of the above examples 1 to 5, and the reference example are illustrated in FIG. 14.

In the examples 1 to 4, all of the inclinations Y are 36.7 GPa. In those cases, in all cases of (a/b)=0.025 to 0.090, the degree of fan d is 2 mm or lower, and the positive electrode 11 has no rucks or corrugation, and are smooth.

In the example 5, the inclination Y is 35.5 GPa, and (a/b)=0.040, but the positive electrode 11 has no strain and is smooth.

In the comparative example, the inclination Y is 35.5 GPa, and (a/b)=0.090. In this case, the degree of fan d is large, that is, 6 mm, and the positive electrode 11 is strained and corrugated.

The determination on the deformation of the positive electrode 11 by the degree of fan is based on whether the positive electrode metal foil 11a is strained and corrugated, or not, after the tensile force of 10 MPa is applied to the positive electrode metal foil 11a from both sides thereof.

In this determination standard, it is determined that the degree of fan d which is 3 mm or lower is determined as pass when the length L of the positive electrode metal foil 11a is 1 m.

According to the above determination standard, only the comparative example is rejected, and all of the examples 1 to 5 are passed.

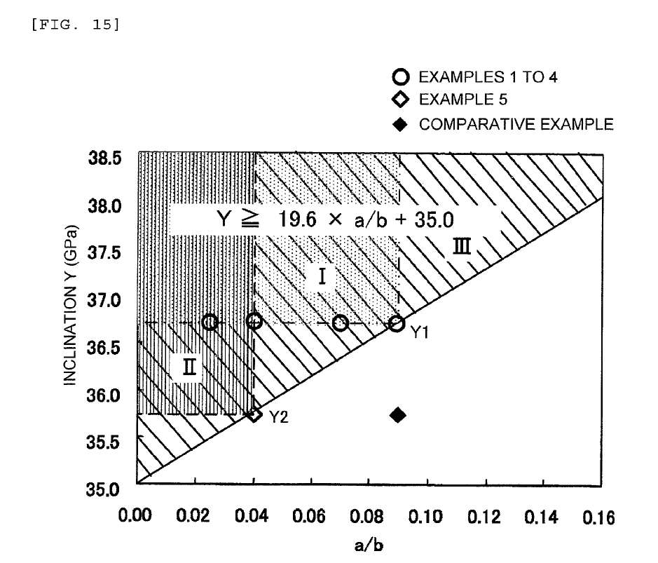

FIG. 15 illustrates the measurement results illustrated in FIG. 14 as the inclination Y-a/b characteristic.

An area I surrounded by a two-dot chain line and hatched with a large number of fine dots corresponds to the measurement results of the examples 1 to 4. In the area I, the inclination Y is 36.7 GPa or larger, (a/b) is equal to or lower than 0.090, and the positive electrode 11 is small in the degree of fan, and has a smooth surface.

An area II surrounded by a dotted line and hatched with vertical lines corresponds to the measurement results of the example 5. That is, in the area II, the inclination Y is 35.7 GPa or larger, (a/b) is equal to or lower than 0.040, and the positive electrode 11 is not strained and corrugated, and has a smooth surface.

Thus, the areas I and II are pass areas in which the degree of fan d is 2 mm or lower. However, even when the inclination Y and the degree of fan are different from those in the examples, there is a pass area in which the degree of fan d is 2 mm or lower.

This will be described.

In FIGS. 14 and 15, the degree of fan d becomes smaller as the inclination Y is larger. Also, when the inclination Y is identical, as (a/b), which is the ratio of the width a of the continuous area portion 11c1 in the positive electrode mix unprocessed portion 11c, and the width b of the positive electrode mix layer 11b, is smaller, the degree of fan d becomes smaller.

Therefore, when the degree of fan is reduced, among the examples 1 to 4 in which the inclination Y is 36.7 GPa, the example 4 in which (a/b) is maximum is worst in the conditions. Also, the example 5 in which the inclination Y is 35.7 GPa is worse in the conditions than the examples 1 to 4.

Therefore, a line connecting the example 4 (Y1 indicated in FIG. 15) and the example 5 (Y2 indicated in FIG. 15) indicates a boundary between pass and rejection in the measurement results, and at least the upper portion of the line is a pass area in which the degree of fan is smaller. In FIG. 15, the pass area is indicated as an area III in which an upper side of the line is obliquely hatched.

A range of the above area III is represented by the following Expression (1) by obtaining the line passing Y1 and Y2 in FIG. 15.

Y≧19.6×(a/b)+35.0 Ex. (1)

In this example, the range of the area III is not a threshold value for the comparative example, but an area in which at least that the degree of fan d is 2 mm or lower is ensured.

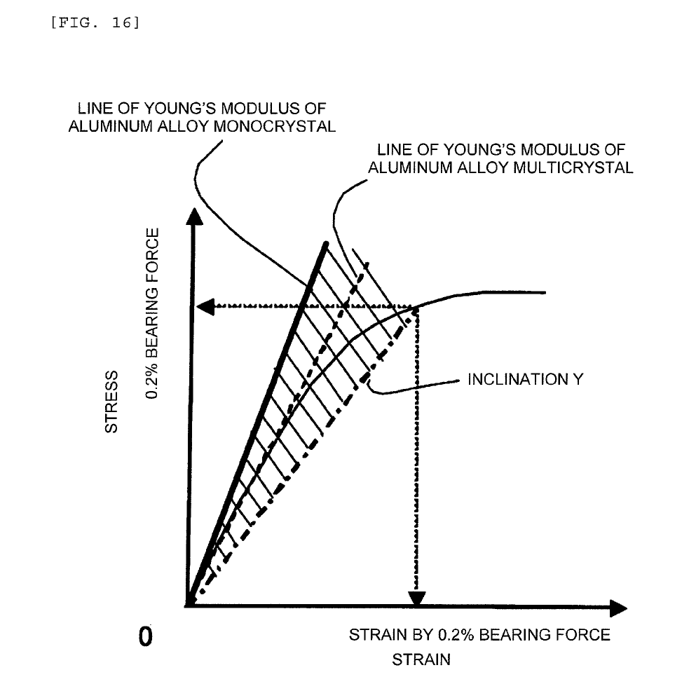

FIG. 16 is a diagram illustrating an upper limit of the inclination Y in the stress (σ)-strain (ε) characteristic curve.

As described above, the strain by the hot pressing becomes smaller as the inclination Y is larger. In order to make the degree of fan infinitely close to zero, there is a need to manufacture the battery in a range where the positive electrode metal foil 11a acts as an elastic body. That is, the inclination Y is equal to the Young's modulus of the used material. When the aluminum alloy is used as the positive electrode metal foil 11a, the inclination Y does not exceed the young's modulus 70 GPa of aluminum alloy monocrystal. Therefore, the positive electrode metal foil 11a made of the aluminum alloy stratifies the following Expression (2).

70.0>Y≧19.6×(a/b)+35.0 EX. (2)

However, the young's modulus 70 GPa is a value in the case of ideal aluminum which is in a monocrystal state. In the aluminum alloy containing manganese or magnesium used industrially, the Young's modulus (slope to elastic limit) obtained from the stress-strain characteristic curve is smaller than 70 GPa, that is, 51 GPa. Therefore, a value of the useful slope Y satisfies the following Expression (3).

51.0>Y≧19.6×(a/b)+35.0 EX. (3)

According to the above Expressions (1) to (3), if the width a of the continuous area portion 11c1 of the positive electrode mix unprocessed portion 11c is 0, the inclination Y may be 35.0 at a minimum. That is, the most deformable material may be used.

However, when a=0, in a process of forming the positive electrode leads 16 with the use of a die cut machine illustrated in FIG. 7, a part of the positive electrode mix is caused to be cut on the side edge along the longitudinal direction due to a variation in coating of the positive electrode mix, and the positive electrode mix is peeled off due to the stress at the time of cutting. The peeled positive electrode mix is adhered to the electrode group 10 to cause the internal short-circuiting or the deterioration of performance. Therefore, actually, the width a of the continuous area portion 11c1 of the positive electrode mix unprocessed portion 11c needs a reasonable value.

In the existing technical level, (a/b)≧0.010 is desirable, and (a/b)≧0.030 is more desirable.

Also, in an upper limit of (a/b), as is apparent with reference to FIG. 15, in principle, if (a/b) is increased in correspondence with an increase in the value of the inclination Y, the above Expressions (1) to (3) are satisfied.

However, when (a/b) becomes larger, the thickness of the positive electrode metal foil 11a becomes larger in order to suppress an increase in the resistance value, and the amount of positive electrode active material per volume is reduced with the result that the battery performance is degraded. Also, since an increase in (a/b) means an increase in the exposed area of the positive electrode metal foil 11a, a possibility that the positive electrode leads 16 are broken in a process of forming the positive electrode leads 16, or in a process of welding the positive electrode leads 16 to the positive electrode current collector member 27, becomes large. For that reason, in the existing technical level, it is desirable that (a/b) is set to be smaller than about 0.090.

As described above, in the lithium ion secondary battery according to the present invention, the positive electrode 11 has one side edge along a longitudinal direction thereof exposed as the positive electrode mix unprocessed portion 11c, and the positive electrode mix layer 11b coated in the other area, on both surfaces of the positive electrode metal foil 11a made of an aluminum alloy, and satisfies a relationship represented by the following Expression (1) when it is assumed that a width of the continuous area portion 11c1 of the positive electrode mix unprocessed portion 11c is a, and a width of the positive electrode mix layer is b.

Y≧19.6×(a/b)+35.0 (1)

where Y is an inclination of a line connecting a cross point between a 0.2% bearing force and a strain at that time, and a point of strain=0 and stress=0 in a stress-strain characteristic curve.

For that reason, there can be obtained such an advantage that the degree of curvature of the positive electrode is reduced without an increase in the number of processes.

In the above embodiment, the case of the positive electrode has been described. However, the present invention can be applied to the negative electrode, likewise. However, the negative electrode foil configuring the negative electrode is usually formed of a copper foil having a larger Young's modulus of about 130 GPa. In this material having the large yield stress, since the degree of curvature is small, the internal short-circuiting and the degradation of the battery performance are not largely problematic in manufacturing the lithium ion secondary battery.

Therefore, the present invention is not essentially applied to the negative electrode side, and may be applied to at least the positive electrode formed of aluminum metal foil.

Also, in the above embodiment, the cylindrical lithium ion secondary battery 1 has been described.

However, the present invention can be also applied to the rectangular lithium ion secondary battery having the winding type electrode group. In the case of the rectangular lithium ion secondary battery, a structure in which the conductive leads are not formed on the mix unprocessed portion of the positive and negative electrodes, but a current collector is welded directly thereon is general. In this structure, the overall positive electrode mix unprocessed portion of the positive electrode metal foil is the continuous area portion.

In addition, the lithium ion secondary battery according to the present invention can be variously modified and applied without departing from the spirit of the present invention. In short, according to the present invention, in a lithium ion secondary battery in which a winding type electrode group including a positive electrode having a positive electrode mix layer containing a lithium metal oxide, a negative electrode having a negative mix layer that stores and discharges lithium ions, and separators arranged on inner and outer peripheries of the positive electrode and the negative electrode is housed, and a nonaqueous electrolyte is poured, within a battery container, the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Expression (1) when it is assumed that a width of a continuous area portion of the positive electrode mix unprocessed portion is a, and a width of the positive electrode mix layer is b.

Y≧19.6×(a/b)+35.0 (1)

where Y is an inclination of a line connecting a cross point between a 0.2% bearing force and a strain at that time, and a point of strain=0 and stress=0 in a stress-strain characteristic curve.

Also, according to the present invention, in a lithium ion secondary battery in which a winding type electrode group including a positive electrode having a positive electrode mix layer containing a lithium metal oxide, a negative electrode having a negative mix layer that stores and discharges lithium ions, and separators arranged on inner and outer peripheries of the positive electrode and the negative electrode is housed, and a nonaqueous electrolyte is poured, within a battery container, the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Condition (I) or Condition (II) when it is assumed that a width of a continuous area portion of the positive electrode mix unprocessed portion is a, and a width of the positive electrode mix layer is b.

Y is equal or larger than 36.7 GPa, and (a/b) is equal to or lower than 0.09 Condition (I), and

Y is equal or larger than 35.7 GPa, and (a/b) is equal to or lower than 0.04 Condition (II)

where Y is an inclination of a line connecting a cross point between a 0.2% bearing force and a strain at that time, and a point of strain=0 and stress=0 in a stress-strain characteristic curve.

The lithium ion secondary battery according to the present invention is mainly intended for, for example, hybrid vehicles, electric vehicles, large-sized secondary batteries for a backup power supply. That is, the lithium ion secondary battery according to the present invention is suitable as several Ah to several tens Ah class.

Various embodiments and modified examples have been described above. However, the present invention is not limited to those contents. The other aspects conceivable without departing from the technical concept of the present invention also fall within the scope of the present invention.

The contents of the following priority basic application are incorporated herein by reference.

Japanese Patent Application No. 2010-288258 (filed on Dec. 24, 2010)

1-6. (canceled)

7. A lithium ion secondary battery in which a winding type electrode group is housed, and a nonaqueous electrolyte is poured within a battery container, the winding type electrode group comprising:
a positive electrode having a positive electrode mix layer containing a lithium metal oxide;
a negative electrode having a negative electrode mix layer that stores and discharges lithium ions; and
separators arranged on inner and outer peripheries of the positive electrode and the negative electrode, wherein the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Expression (1) when it is assumed that a width of a continuous area portion of the positive electrode mix unprocessed portion is a, and a width of the positive electrode mix layer is b.
Y≧19.6×(a/b)+35.0 (1)
where Y is an inclination of a line connecting a cross point between a 0.2% bearing force and a strain at that time, and a point of strain=0 and stress=0 in a stress-strain characteristic curve.

8. A lithium ion secondary battery in which a winding type electrode group is housed, and a nonaqueous electrolyte is poured within a battery container, the winding type electrode group comprising:
a positive electrode having a positive electrode mix layer containing a lithium metal oxide;
a negative electrode having a negative electrode mix layer that stores and discharges lithium ions; and
separators arranged on inner and outer peripheries of the positive electrode and the negative electrode,
wherein the positive electrode has one side edge along a longitudinal direction thereof exposed as a positive electrode mix unprocessed portion, and a positive electrode mix layer coated in the other area on both surfaces of a metal foil made of an aluminum alloy, and satisfies a relationship represented by the following Condition (I) or Condition (II) when it is assumed that a width of a continuous area portion of the positive electrode mix unprocessed portion is a, and a width of the positive electrode mix layer is b.
Y is equal or larger than 36.7 GPa, and (a/b) is equal to or lower than 0.09 Condition (I), and
Y is equal or larger than 35.7 GPa, and (a/b) is equal to or lower than 0.04 Condition (II)
where Y is an inclination of a line connecting a cross point between a 0.2% bearing force and a strain at that time, and a point of strain=0 and stress=0 in a stress-strain characteristic curve.

9. The lithium ion secondary battery according to claim 7, wherein a ratio of the width a of the continuous area portion of the positive electrode mix unprocessed portion and the width b of the positive electrode mix layer satisfies 0.01≦(a/b)≦0.09.

10. The lithium ion secondary battery according to claim 8, wherein a ratio of the width a of the continuous area portion of the positive electrode mix unprocessed portion and the width b of the positive electrode mix layer satisfies 0.01≦(a/b)≦0.09.

11. The lithium ion secondary battery according to claim 7, wherein a ratio of the width a of the continuous area portion of the positive electrode mix unprocessed portion and the width b of the positive electrode mix layer satisfies 0.03≦(a/b)≦0.09.

12. The lithium ion secondary battery according to claim 8, wherein a ratio of the width a of the continuous area portion of the positive electrode mix unprocessed portion and the width b of the positive electrode mix layer satisfies 0.03≦(a/b)≦0.09.

13. The lithium ion secondary battery according 7, wherein a thickness of the metal foil is 10 to 20 μm.

14. The lithium ion secondary battery according to claim 13, wherein the winding type electrode group is a cylindrical, and the positive electrode mix unprocessed portion has a positive electrode lead extended from the continuous area portion to an external.
